(19) United States
(12) Patent Application Publication
(10) Pub. No.: US 2025/0252148 A1
(43) Pub. Date: Aug. 7, 2025

(54) PAGE VERSION CONFIGURATION METHOD, MEDIUM, AND ELECTRONIC DEVICE

(71) Applicant: Beijing Youzhuju Network Technology Co., Ltd., Beijing (CN)

(72) Inventor: Li JIA, Beijing (CN)

(21) Appl. No.: 19/043,242

(22) Filed: Jan. 31, 2025

(30) Foreign Application Priority Data
Feb. 1, 2024 (CN) 202410146599.3

(51) Int. Cl. G06F 16/957; G06F 16/958

(52) U.S. Cl. CPC G06F 16/9577; G06F 16/958

(57) ABSTRACT

A page version configuration method, a medium, and an electronic device are provided. The method includes: displaying a configuration interface, in which the configuration interface includes style layout templates of a plurality of versions of a target page and business data of a plurality of versions of the target page, and the business data includes variables declared in the style layout templates and user-defined functions; and creating a to-be-published version of the target page in response to a configuration operation performed based on the configuration interface, in which the configuration operation is used to select a style layout template that constitutes the to-be-published version and/or business data used to fill the style layout template.

### CROSS-REFERENCE TO RELATED APPLICATION

This application claims the priority of Chinese Patent Application No. 202410146599.3 filed on Feb. 1, 2024, the disclosure of which is incorporated by reference herein in its entirety as part of the present application.

### TECHNICAL FIELD

Embodiments of the present disclosure relates to the field of Internet technologies, and in particular, to a page version configuration method and apparatus, a medium, and an electronic device.

### BACKGROUND

In the related art, a user accesses a page through a link provided by a front end, and the front end requests a back end to implement acquisition of the page and displays the page to the user. In page display, the user cares about whether data content in the page is displayed normally. However, when an abnormal situation occurs in a data service provided by the back end, the data cannot be acquired to continuously display the page normally to the user.

### SUMMARY

This Summary is provided to introduce concepts in a simplified form, the concepts are described in detail in the following Detailed Description section. This Summary section is not intended to identify key features or essential features of the claimed technical solution, nor is it intended to be used to limit the scope of the claimed technical solution.

In a first aspect, the embodiments of the present disclosure provide a page version configuration method, which includes:
displaying a configuration interface, in which the configuration interface includes style layout templates of a plurality of versions of a target page and business data of a plurality of versions of the target page, and the business data includes a variable declared in the style layout templates and a user-defined function; and
creating a to-be-published version of the target page in response to a configuration operation performed based on the configuration interface, in which the configuration operation is used to select a style layout template that constitutes the to-be-published version and/or business data used to fill the style layout template.

In a second aspect, the embodiments of the present disclosure provide a page version configuration apparatus, which includes:
a display module, configured to display a configuration interface, in which the configuration interface includes style layout templates of a plurality of versions of a target page and business data of a plurality of versions of the target page, and the business data includes a variable declared in the style layout templates and a user-defined function; and
a configuration module, configured to create a to-be-published version of the target page in response to a configuration operation performed based on the configuration interface, in which the configuration operation is used to select a style layout template that constitutes the to-be-published version and/or business data used to fill the style layout template.

In a third aspect, the embodiments of the present disclosure provide a computer-readable medium having a computer program stored thereon, the program, when executed by a processing apparatus, implements the steps of the method according to the first aspect.

In a fourth aspect, the embodiments of the present disclosure provide an electronic device, which includes:
a storage apparatus having a computer program stored thereon; and
a processing apparatus configured to execute the computer program in the storage apparatus to implement the steps of the method according to the first aspect.

### BRIEF DESCRIPTION OF DRAWINGS

The above and other features, advantages, and aspects of the embodiments of the present disclosure become more apparent with reference to the following detailed description in conjunction with the drawings. Throughout the drawings, the same or similar reference numerals denote the same or similar elements. It should be understood that the drawings are schematic and the components and elements are not necessarily drawn to scale. In the drawings:

FIG. 1 is a flowchart of a page version configuration method according to an exemplary embodiment of the present disclosure;

FIG. 2 is a flowchart of style layout templates of two versions according to an exemplary embodiment of the present disclosure;

FIG. 3 is a schematic diagram of processes of a fast publishing mode and a slow publishing mode according to an exemplary embodiment of the present disclosure;

FIG. 4 is a schematic diagram of rendering a target page according to an exemplary embodiment of the present disclosure;

FIG. 5 is a block diagram of a page version configuration apparatus according to an exemplary embodiment of the present disclosure; and

FIG. 6 is a structural diagram of an electronic device according to an exemplary embodiment of the present disclosure.

### DETAILED DESCRIPTION

Embodiments of the present disclosure are described in more detail below with reference to the drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the drawings and the embodiments of the present disclosure are only for illustrative purposes and are not intended to limit the scope of protection of the present disclosure.

It should be understood that the various steps described in the method implementations of the present disclosure may be performed in different orders, and/or performed in parallel. Furthermore, additional steps may be included and/or execution of the illustrated steps may be omitted in the method implementations. The scope of the present disclosure is not limited in this regard.

The term “comprise/include” used herein and variations thereof are open-ended inclusions, that is, “comprise/include but not limited to”. The term “based on” is “at least partially based on”. The term “one embodiment” means “at least one embodiment”; the term “another embodiment” means “at least one additional embodiment”; and the term “some embodiments” means “at least some embodiments”. Relevant definitions of other terms will be given in the description below.

It should be noted that the concepts of “first” and “second” mentioned in the present disclosure are only used to distinguish different devices, modules, or units, and are not used to limit the order or interdependence of functions performed by these devices, modules, or units.

It should be noted that the modifiers “one” and “a plurality” mentioned in the present disclosure are illustrative rather than restrictive, and those skilled in the art should understand that unless the context clearly indicates otherwise, they should be understood as “one or more”.

The names of messages or information exchanged between multiple apparatuses in the implementations of the present disclosure are only for illustrative purposes, and are not used to limit the scope of the messages or information.

It should be understood that before using the technical solutions disclosed in the embodiments of the present disclosure, users should be informed of the types, range of use, usage scenarios, and the like of personal information involved in the present disclosure in an appropriate manner in accordance with relevant laws and regulations, and user authorization should be obtained.

For example, in response to receiving an active request from a user, prompt information is sent to the user, to clearly inform the user that the operation requested to be performed will require the acquisition and use of the user's personal information. Therefore, the user can independently choose whether to provide personal information to software or hardware, such as an electronic device, an application, a server, or a storage medium, that performs the operations of the technical solutions of the present disclosure, according to the prompt information.

As an optional but non-limiting implementation, in response to receiving an active request from the user, the prompt information may be sent to the user in the form of a pop-up window, for example, and the prompt information may be presented in text in the pop-up window. In addition, the pop-up window may also include a selection control for the user to choose whether to “agree” or “disagree” to provide the personal information to the electronic device.

It should be understood that the above process of notifying and acquiring the user's authorization is only illustrative and does not limit the embodiments of the present disclosure, and other methods that meet relevant laws and regulations may also be applied to the implementations of the present disclosure.

At the same time, it can be understood that the data involved in the technical solution (including but not limited to the data itself, the acquisition or use of the data) should comply with the requirements of corresponding laws, regulations, and related provisions.

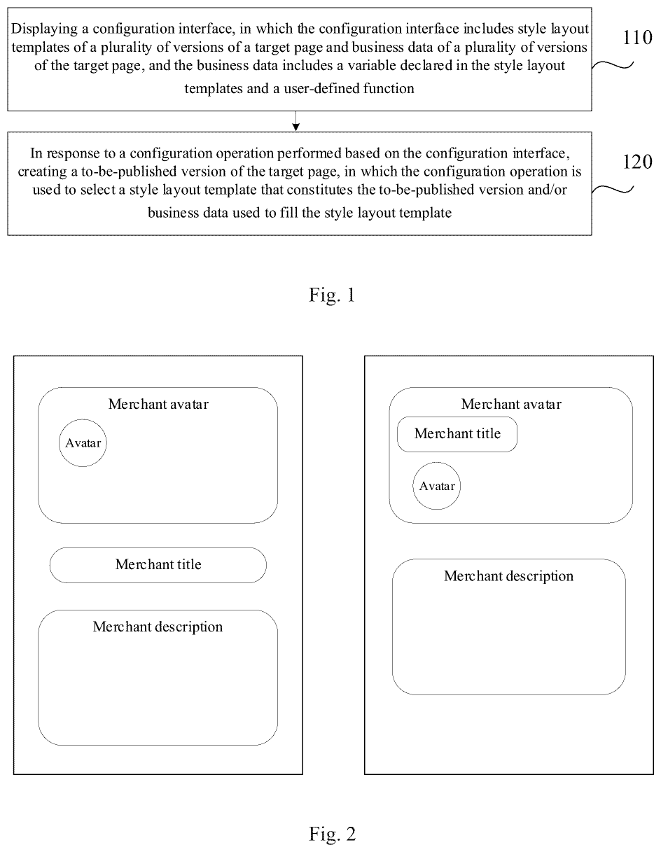

FIG. 1 is a flowchart of a page version configuration method according to an exemplary embodiment of the present disclosure. The page version configuration method may be performed by an electronic device, and may specifically be performed by a page version configuration apparatus, which may be implemented by software and/or hardware. Referring to FIG. 1, the page version configuration method may include the following steps.

Step 110: displaying a configuration interface, in which the configuration interface includes style layout templates of a plurality of versions of a target page and business data of a plurality of versions of the target page, and the business data includes a variable declared in the style layout templates and a user-defined function.

Step 120: in response to a configuration operation performed based on the configuration interface, creating a to-be-published version of the target page, in which the configuration operation is used to select a style layout template that constitutes the to-be-published version and/or business data used to fill the style layout template.

The target page may be a Web page, and may specifically be a landing page.

The style layout template is used to represent the layout of page contents in the target page, and the business data is used to represent the page contents and the business logic for implementing a business, the page contents may be a text, an image, a video, etc. In this embodiment, the business data includes a variable declared in the style layout templates and a user-defined function, the variable declared in the layout templates represents the page contents, and the user-defined function represents the business logic.

With the above technical solutions, a page is divided in units of style layout templates and business data, and page version reconfiguration is performed in units of style layout templates and business data based on a configuration interface. Based on this, the display of the target page is implemented based on the reconfigured to-be-published version of the target page, thereby improving the disaster recovery capability of the landing page.

FIG. 2 is a flowchart of style layout templates of two versions according to an exemplary embodiment of the present disclosure. In FIG. 2, a merchant avatar, an avatar, a merchant title, and a merchant description are all different page contents that constitute the target page, positions of the merchant avatar, the avatar, the merchant title, and the merchant description in the target page in the two versions are different, so that page layouts of the page presented to the client are different.

The configuration operation is used to select a style layout template that constitutes the to-be-published version and/or business data used to fill the style layout template. As an example, the configuration operation may be used to update page data in a historical version of the target page, and create the to-be-published version of the target page to update the version of the target page. For example, when the display of the target page corresponding to the version in the effective state is faulty on the client, for example, when a certain page content in the target page cannot be displayed, only the business data corresponding to the corresponding page content in the historical version may be modified, so that the to-be-published version is created.

It should be noted that a corresponding version may be in the effective state by publishing the version; and correspondingly, a published version may be taken offline, so that the corresponding version is in an ineffective state. In a page request for the target page, rendering and display of the page are implemented according to the effective version.

When the display of the target page is faulty, for example, when the page content in the page cannot be displayed normally, the page is divided in units of style layout templates and business data through the above method, and the operation personnel can reconfigure the page version in units of style layout templates and business data based on the configuration interface, thereby improving the readability of page version configuration. Based on this, the normal display of the target page is implemented based on the reconfigured to-be-published version of the target page, thereby improving the disaster recovery capability of the landing page in a disaster recovery scenario.

In some embodiments, the above step of creating the to-be-published version of the target page in response to the configuration operation performed based on the configuration interface may be implemented in the following manner: displaying a historical version of the target page in the configuration interface; and in response to an change operation for the historical version based on the configuration interface, creating the to-be-published version of the target page.

In this embodiment, the to-be-published version is obtained by changing the historical version, that is, at least part of information in the to-be-published version and the historical version is the same, the part of information may be the style layout template or the business data.

In this embodiment, the configuration operation includes the change operation, and the change operation is used to change the style layout template and/or the business data in the historical version. For example, as shown in FIG. 2, the change operation may be to change the “avatar”.

Through the above method, the historical version of the target page is updated to obtain a new version of the target page. Based on this, rendering and display of the target page can be implemented based on the published new version, thereby improving the disaster recovery capability of the landing page in the disaster recovery scenario. In addition, by combining the style layout templates of the plurality of versions of the target page and the business data of the plurality of versions of the target page, the display of the target page on the client can be enriched.

In some embodiments, the above page version configuration method may further include the following step: publishing the to-be-published version through a target publishing mode.

The published to-be-published version can respond to a page request for requesting the target page initiated by a client, and based on the page request, the client can display a target page corresponding to the to-be-published version. As an example, the target publishing mode includes a fast publishing mode and a slow publishing mode, and a publishing speed of the fast publishing mode is higher than a publishing speed of the slow publishing mode, that is, the to-be-published version published based on the fast publishing mode can be more quickly applied to a scenario of the page request for the target page.

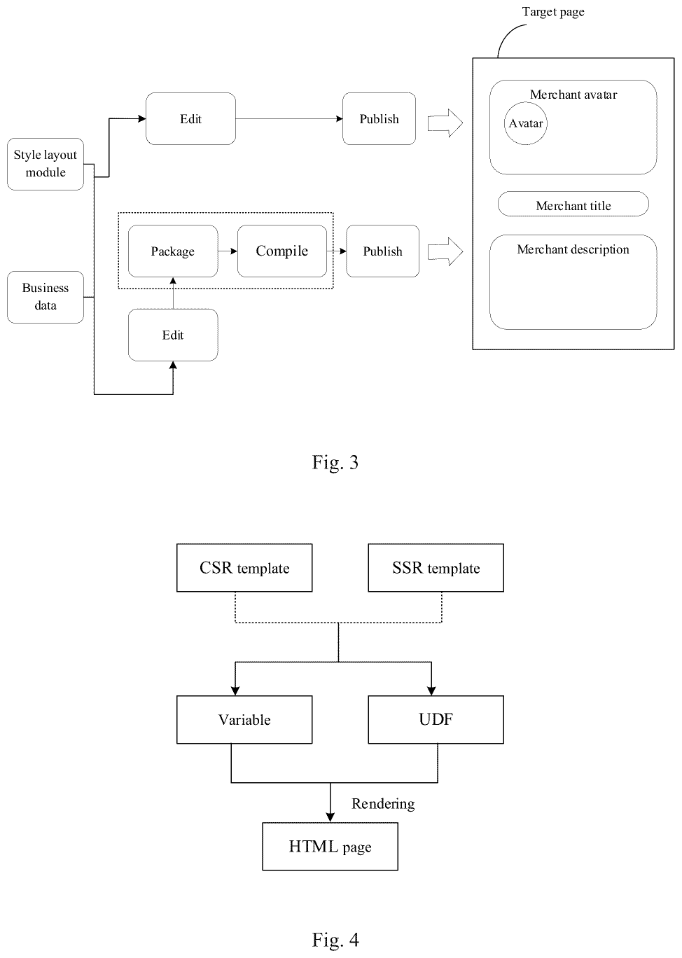

FIG. 3 is a schematic diagram of processes of a fast publishing mode and a slow publishing mode according to an exemplary embodiment of the present disclosure. It should be noted that editing means the above configuration operation, and compared with the fast publishing mode, the slow publishing mode requires packaging and compilation, so that the publishing speed of the fast publishing mode is higher than the publishing speed of the slow publishing mode.

The fast publishing mode may be applied to a disaster recovery scenario, that is, when the display of the target page is faulty, for example, when the page content in the page cannot be displayed normally, the fast publishing mode may be determined as the target publishing mode to implement the publishing of the to-be-published version, so that the target page of the to-be-published version that can be displayed normally can be quickly applied to a scenario of the page request, thereby improving the disaster recovery capability in the scenario of the page request.

The target publishing mode may be determined based on whether a change corresponding to the change operation for the historical version supports the fast publishing mode. For example, the above page version configuration method may further include the following steps: determining whether a change corresponding to the change operation supports the fast publishing mode; in response to the change corresponding to the change operation supporting the fast publishing mode, determining the fast publishing mode as the target publishing mode; and in response to the change corresponding to the change operation not supporting the fast publishing mode, determining the slow publishing mode as the target publishing mode.

In this embodiment, whether the change corresponding to the change operation supports the fast publishing mode may be pre-configured. For example, when the change corresponding to the change operation only changes the position referenced by an image, it may be configured that such a change can support the fast publishing mode. For another example, when the change corresponding to the change operation includes the modification of the user-defined function, it may be determined that such a change does not support the fast publishing mode.

Through the above method, the rational setting of the publishing mode of the page template is implemented.

In some embodiments, the above page version configuration method may further include the following steps: determining a target rendering mode in response to the page request for requesting the target page; and obtaining the target page by: acquiring, through a target rendering end that performs rendering in the target rendering mode, a style layout template corresponding to the to-be-published version and the business data used to fill the style layout template, and performing rendering based on the style layout template and the business data to obtain the target page.

The target rendering mode may be Server-Side Rendering (SSR) or Client-Side Rendering (CSR). As an example, the target rendering mode may be determined based on device data of a device where the client is located, the device data is used to represent the device performance of the device where the client is located, and the device data may be, for example, a device model.

In this embodiment, when the target rendering mode is SSR, the target rendering end is a server side, and the server side acquires, through the page request sent by the client, the style layout template corresponding to the to-be-published version of the target page corresponding to the page request and the business data used to fill the style layout template, performs page rendering to obtain the target page, and returns the target page to the client for display. When the target rendering mode is CSR, the target rendering end is the client, and the server side acquires, through the page request sent by the client, the style layout template corresponding to the to-be-published version of the target page corresponding to the page request and the business data used to fill the style layout template, and returns the above style layout template and the business data to the client. The client performs rendering based on the style layout template and the business data to obtain the corresponding target page for display.

FIG. 4 is a schematic diagram of rendering a target page according to an exemplary embodiment of the present disclosure. As shown in FIG. 4, a CSR template is a style layout template that supports rendering by a client, an SSR template is a style layout template that supports rendering by a server side, and the variable and UDF (user-defined function) are business data for filling the corresponding template. When the client renders, the CSR template is selected, the CSR template is filled based on the variable and the UDF, and rendering is performed based on the filling result to obtain a HyperText Markup Language (HTML) page (that is, a target page). When the server side renders, the SSR template is selected, the SSR template is filled based on the variable and the UDF, and rendering is performed based on the filling result to obtain an HTML page (that is, a target page).

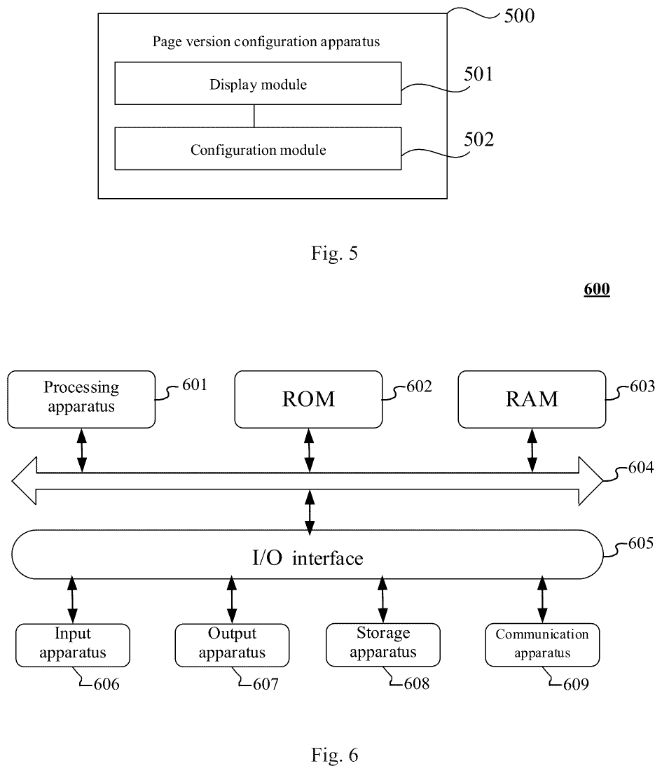

FIG. 5 is a block diagram of a page version configuration apparatus according to an exemplary embodiment of the present disclosure. Referring to FIG. 5, the apparatus 500 may include:
a display module 501, configured to display a configuration interface, in which the configuration interface includes style layout templates of a plurality of versions of a target page and business data of a plurality of versions of the target page, and the business data includes a variable declared in the style layout templates and a user-defined function; and
a configuration module 502, configured to create a to-be-published version of the target page in response to a configuration operation performed based on the configuration interface, in which the configuration operation is used to select a style layout template that constitutes the to-be-published version and/or business data used to fill the style layout template.

Optionally, the configuration module 502 includes:
a first display sub-module, configured to display a historical version of the target page in the configuration interface; and
a first configuration sub-module, configured to create the to-be-published version of the target page in response to a change operation for the historical version based on the configuration interface, in which the change operation is used to change the style layout template and/or the business data in the historical version.

Optionally, the apparatus 500 further includes:
a publishing module, configured to publish the to-be-published version through a target publishing mode, in which the target publishing mode includes a fast publishing mode and a slow publishing mode, a publishing speed of the fast publishing mode is higher than a publishing speed of the slow publishing mode, and a page request for requesting the target page is responded to based on the published to-be-published version.

Optionally, the apparatus 500 further includes:
a response module, configured to determine a target rendering mode in response to the page request for requesting the target page,
the target page is obtained by rendering in the following manner:
acquiring, through a target rendering end that performs rendering in the target rendering mode, a style layout template corresponding to the to-be-published version and the business data used to fill the style layout template, and performing rendering based on the style layout template and the business data to obtain the target page.

Optionally, the apparatus 500 further includes:
a first determination module, configured to determine whether a change corresponding to the change operation supports the fast publishing mode; and
a second determination module, configured to determine the fast publishing mode as the target publishing mode in response to the change corresponding to the change operation supporting the fast publishing mode.

Optionally, the apparatus 500 further includes:
a third determination module, configured to determine the slow publishing mode as the target publishing mode in response to the change corresponding to the change operation not supporting the fast publishing mode.

Implementations of the modules in the apparatus 500 may refer to the above related embodiments, which will not be repeated in this embodiment.

Based on the same concept, the embodiments of the present disclosure further provide a computer-readable medium having a computer program stored thereon, the program, when executed by a processing apparatus, implements the steps of the above page version configuration method.

Based on the same concept, the embodiments of the present disclosure further provide an electronic device, which includes:
a storage apparatus, having a computer program stored thereon; and
a processing apparatus, configured to execute the computer program in the storage apparatus to implement the steps of the above page version configuration method.

Referring to FIG. 6, which illustrates a schematic structural diagram of an electronic device 600 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 6 is merely an example, and should not pose any limitation to the functions and the range of use of the embodiments of the present disclosure.

As illustrated in FIG. 6, the electronic device 600 may include a processing apparatus 601 (e.g., a central processing unit, a graphics processing unit, etc.), which can perform various suitable actions and processing according to a program stored in a read-only memory (ROM) 602 or a program loaded from a storage apparatus 508 into a random-access memory (RAM) 603. The RAM 603 further stores various programs and data required for operations of the electronic device 600. The processing apparatus 601, the ROM 602, and the RAM 603 are interconnected by means of a bus 604. An input/output (I/O) interface 605 is also connected to the bus 604.

Usually, the following apparatus may be connected to the I/O interface 605: an input apparatus 606 including, for example, a touch screen, a touch pad, a keyboard, a mouse, a camera, a microphone, an accelerometer, a gyroscope, or the like; an output apparatus 607 including, for example, a liquid crystal display (LCD), a loudspeaker, a vibrator, or the like; a storage apparatus 608 including, for example, a magnetic tape, a hard disk, or the like; and a communication apparatus 609. The communication apparatus 609 may allow the electronic device 600 to be in wireless or wired communication with other devices to exchange data. While FIG. 6 illustrates the electronic device 500 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 609 and installed, or may be installed from the storage apparatus 608, or may be installed from the ROM 602. When the computer program is executed by the processing apparatus 601, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: display a configuration interface, in which the configuration interface includes style layout templates of a plurality of versions of a target page and business data of a plurality of versions of the target page, and the business data includes a variable declared in the style layout templates and a user-defined function; and in response to a configuration operation performed based on the configuration interface, create a to-be-published version of the target page, in which the configuration operation is used to select a style layout template that constitutes the to-be-published version and/or business data used to fill the style layout template.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims. Specific manners of operations performed by the modules in the apparatus in the above embodiment have been described in detail in the embodiments regarding the method, which will not be explained and described in detail herein again.

1. A page version configuration method, comprising:
displaying a configuration interface, wherein the configuration interface comprises style layout templates of a plurality of versions of a target page and business data of the plurality of versions of the target page, and the business data comprises a variable declared in the style layout templates and a user-defined function; and
in response to a configuration operation performed based on the configuration interface, creating a to-be-published version of the target page, wherein the configuration operation is used to select a style layout template that constitutes the to-be-published version and/or the business data used to fill the style layout template.

2. The method according to claim 1, wherein creating the to-be-published version of the target page in response to the configuration operation performed based on the configuration interface comprises:
displaying a historical version of the target page in the configuration interface; and
in response to a change operation for the historical version based on the configuration interface, creating the to-be-published version of the target page, wherein the change operation is used to change the style layout template and/or the business data in the historical version.

3. The method according to claim 2, further comprising:
publishing the to-be-published version through a target publishing mode, wherein the target publishing mode comprises a fast publishing mode and a slow publishing mode, a publishing speed of the fast publishing mode is higher than a publishing speed of the slow publishing mode, and a page request for requesting the target page is responded to based on the published to-be-published version.

4. The method according to claim 3, further comprising:
in response to the page request for requesting the target page, determining a target rendering mode,
wherein the target page is obtained by rendering in a following manner:
acquiring, through a target rendering end that performs rendering in the target rendering mode, the style layout template corresponding to the to-be-published version and the business data used to fill the style layout template, and performing the rendering based on the style layout template and the business data to obtain the target page.

5. The method according to claim 3, further comprising:
determining whether a change corresponding to the change operation supports the fast publishing mode; and
in response to the change corresponding to the change operation supporting the fast publishing mode, determining the fast publishing mode as the target publishing mode.

6. The method according to claim 5, further comprising:
in response to the change corresponding to the change operation not supporting the fast publishing mode, determining the slow publishing mode as the target publishing mode.

7. A non-transitory computer-readable medium, having a computer program stored thereon, wherein the program, when executed by a processing apparatus, implements a page version configuration method, the method comprises:
displaying a configuration interface, wherein the configuration interface comprises style layout templates of a plurality of versions of a target page and business data of the plurality of versions of the target page, and the business data comprises a variable declared in the style layout templates and a user-defined function; and
in response to a configuration operation performed based on the configuration interface, creating a to-be-published version of the target page, wherein the configuration operation is used to select a style layout template that constitutes the to-be-published version and/or the business data used to fill the style layout template.

8. An electronic device, comprising:
a storage apparatus, having a computer program stored thereon; and
a processing apparatus, configured to execute the computer program in the storage apparatus to:
display a configuration interface, wherein the configuration interface comprises style layout templates of a plurality of versions of a target page and business data of the plurality of versions of the target page, and the business data comprises a variable declared in the style layout templates and a user-defined function; and
in response to a configuration operation performed based on the configuration interface, create a to-be-published version of the target page, wherein the configuration operation is used to select a style layout template that constitutes the to-be-published version and/or the business data used to fill the style layout template.

9. The electronic device according to claim 8, wherein the processing apparatus is further configured to execute the computer program to:
display a historical version of the target page in the configuration interface; and
in response to a change operation for the historical version based on the configuration interface, create the to-be-published version of the target page, wherein the change operation is used to change the style layout template and/or the business data in the historical version.

10. The electronic device according to claim 9, wherein the processing apparatus is further configured to execute the computer program to:
publish the to-be-published version through a target publishing mode, wherein the target publishing mode comprises a fast publishing mode and a slow publishing mode, a publishing speed of the fast publishing mode is higher than a publishing speed of the slow publishing mode, and a page request for requesting the target page is responded to based on the published to-be-published version.

11. The electronic device according to claim 10, wherein the processing apparatus is further configured to execute the computer program to:
in response to the page request for requesting the target page, determine a target rendering mode,
wherein the target page is obtained by rendering in a following manner:
acquiring, through a target rendering end that performs rendering in the target rendering mode, the style layout template corresponding to the to-be-published version and the business data used to fill the style layout template, and performing the rendering based on the style layout template and the business data to obtain the target page.

12. The electronic device according to claim 10, wherein the processing apparatus is further configured to execute the computer program to:
determine whether a change corresponding to the change operation supports the fast publishing mode; and
in response to the change corresponding to the change operation supporting the fast publishing mode, determine the fast publishing mode as the target publishing mode.

13. The electronic device according to claim 12, further comprising:
in response to the change corresponding to the change operation not supporting the fast publishing mode, the processing apparatus is further configured to determine the slow publishing mode as the target publishing mode.
